(19) United States
(12) Patent Application Publication
(10) Pub. No.: US 2013/0220387 A1
(43) Pub. Date: Aug. 29, 2013

(54) WATER AND DEBRIS RECOVERY SYSTEM

(71) Applicant: James Crocker, Stuart, FL (US)

(72) Inventor: James Crocker, Stuart, FL (US)

(21) Appl. No.: 13/767,442

(22) Filed: Feb. 14, 2013

Related U.S. Application Data
(60) Provisional application No. 61/598,763, filed on Feb. 14, 2012.

(51) Int. Cl. B08B 3/02

(52) U.S. Cl. CPC B08B 3/02
USPC 134/111

(57) ABSTRACT

The present system relates to a water and debris recovery system for a water blasting device or water demolition system suitable for mounting upon the frame of a mobile vehicle for easy transport and use. The system includes a liquid reservoir connected to a high pressure fluid pump for directing ultra-high pressure water through a blast head to remove the coatings or markings from a surface. The blast head includes a shroud which surrounds the blasting area to at least partially contain the water and debris dislodged from the surface. A vacuum pump is secured to the shroud with the vacuum passing through a cyclone type separator allowing the water and debris to settle to the bottom portion of the cyclone. A mud type pump is then utilized to transfer the collected water and debris into an open top tank.

### RELATED APPLICATIONS

In accordance with 37 C.F.R 1.76, a claim of priority is included in an Application Data Sheet filed concurrently herewith. Accordingly, the present invention claims priority under 35 U.S.C. §119(e) to U.S. Provisional Application 61/598,763, entitled “WATER AND DEBRIS RECOVERY SYSTEM”, filed on Feb. 14, 2012. The contents of each of the above referenced applications are herein incorporated by reference in its entirety.

### FIELD OF THE INVENTION

This invention relates to the field of high pressure water cleaning devices for highways, airport runways, parking decks, subway stations, ships and other hard surfaces.

### BACKGROUND OF THE INVENTION

Surface cleaning apparatus such as pressure washers are useful for cleaning a variety of objects. Such devices require a clean supply of water for proper operation, but create wastewater by entraining solids from the cleaned surface into the used source water. Although there are many types of pressure washing systems, a typical system utilizes an engine that powers a pump. The inlet side of the pump is connected to a low pressure water source such as a tank or a municipal water supply, while the high pressure side of the pump is connected to a high pressure hose and wand for controlling the flow of high pressure water generated by the pump. The high pressure water is directed at a surface to dislodge dirt, paint and the like, and the water is generally allowed to drain into the storm sewer.

Ultra-high pressure washers, supplying more than 25,000 P.S.I. are also known. These systems include a large engine, typically diesel, which operates a large multi-cylinder pump to generate high volumes of water at ultra-high pressures. The ultra-high pressure water is directed through piping and/or hoses to various types of blast heads suitable for controlling the flow and direction of the ultra-high pressure water. One particular use for ultra-high pressure water devices is the removal of stripes or other markings from road surfaces. When polymers such as paint or plastic are used for roadway marking, the surface of the pavement is penetrated from ⅛-⅜ inch; whereby water blasting is the only known method of removing the stripe material from below the surface without removing a portion of the roadway surface. Ultra-high pressure water washers are also utilized for removing paint from ships, cleaning industrial facilities, removing graffiti, removing rubber from aircraft runways and demolition.

One problem associated with both low and ultra-high pressure water cleaning equipment is maintaining an adequate supply of clean water for continuous operation of the system. Dirty or contaminated water causes numerous problems with water cleaning equipment such as excessive pump wear, clogged filters, nozzles, screens and the like. Because cleaning often needs to take place away from municipal water supplies, water is often transported to the cleaning site. Because the water cleaning equipment requires large volumes of water to be effective, additional equipment is needed to haul in tanks of water. Alternatively, cleaning must be stopped so that additional water may be obtained.

The problem of hauling sufficient water to a job site with the truck is exacerbated by the vacuum tanks used to recover the water and debris. The vacuum tanks are large and therefore must be made incredibly strong to stand up to the vacuum pressure applied over the large internal surface area. The required strength adds significant weight to the assembly and thus to the vehicle carrying the tank reducing the amount of clean water than can be carried by the same vehicle for blasting the surface.

Therefore, what is needed in the art is a system for revering water and debris from a waterblasting or water demolition project that does not require a vacuum tank to retain all of the water and debris collected from the blast head. The system should utilize vacuum for recovery of the water and debris which can then be pumped to an open top tank for dewatering or disposal. The recovery system should be compact for mounting on various types of vehicles, trailer and skids.

### SUMMARY OF THE INVENTION

Briefly, disclosed is a water and debris recovery system for a water blasting device or water demolition system, the system being suitable for mounting upon the frame of a mobile vehicle for easy transport and use. The system includes a liquid reservoir connected to a high pressure fluid pump for directing ultra-high pressure water through a blast head to remove the coatings or markings from a surface. The blast head is mounted on a vehicle and includes a shroud which surrounds the blasting area to at least partially contain the water and debris dislodged from the surface. A vacuum pump is secured to the shroud with the vacuum passing through a cyclone type separator allowing the water and debris to settle to the bottom portion of the cyclone while the air is allowed to vent to the atmosphere. A unique debris type pump containing a diaphragm or piston is then utilized to transfer the collected water and debris into an open top tank or other tank not containing vacuum for transport or dewatering.

Accordingly, it is an objective of the instant invention to provide a water and debris recovery system which can be readily transported.

It is a further objective of the instant invention to provide a water and debris recovery system that does not need a vacuum tank for the recovery of the water and debris.

It is yet another objective of the instant invention to provide a unique debris pump suitable for transferring water and debris.

It is still another objective of the instant invention to provide a debris pump suitable for transfer of sticky polymeric materials.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic representation of the water and debris recovery system of the present invention, illustrated with a piston type mud pump;

FIG. 2 is a schematic representation of the water and debris recovery system of the present invention, illustrated with a diaphragm type mud pump.

### DETAILED DESCRIPTION OF THE INVENTION

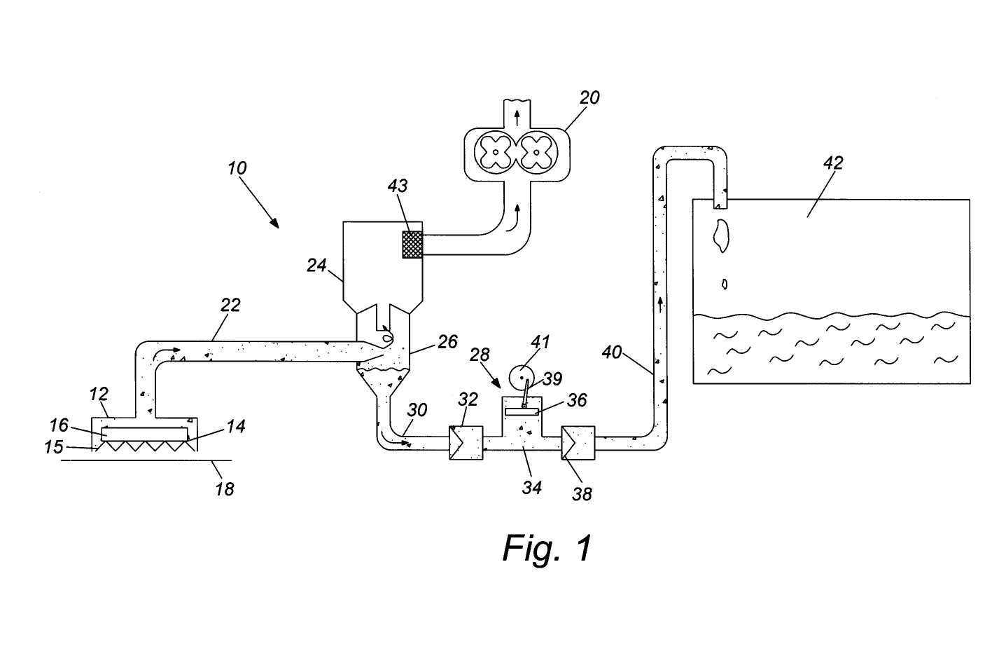

Referring to FIG. 1, the water and debris recovery system 10 is illustrated. The system begins at the blast head 12 where high pressure water 15 is directed through nozzles secured to rotationally mounted spray bar 16. The high pressure water impinges on the surface 18 removing surface markings as well as any loose debris which is trapped within the shroud. Vacuum pump 20 provides a negative air flow through the shroud to draw the water and debris into tube 22. The vacuum pump is preferably a roots type blower however, any pump or fan suitable for creating sufficient vacuum, e.g. negative air pressure, to transfer the water and debris is suitable. Water and debris from tube 22 is directed into a separator which is preferably a one or two stage cyclonic separator 24 which allows the water and debris to fallout of the vacuum air flow into the bottom portion 26 of the separator 24. An air filter 43 may be provided to prevent small particles from entering the vacuum pump 20. Reciprocating piston 36 of the mud pump 28 then draws the water and debris mix through tube 30 and a first check valve 32 into the central portion of the mud pump 34 for ejection through a second check valve 38. This cycle continues until the water and debris mix is pushed through tube 40 into open tank 42. The mud pump 28 preferably includes at least reciprocating piston 36 which may be replaced with a diaphragm, bladder or the like. The piston or diaphragm is preferably connected to an offset wheel or crankshaft which may allow the stroke of the piston to be adjusted as needed to vary the volume of the pump chamber and thus the volume of fluid and debris transferred during each rotation of the crankshaft. Check valves 32 and 38 are preferably constructed of a material that resists adhesion to sticky polymers and the like which may be found on the surfaces being cleaned. In a most preferred embodiment the check valves are constructed from a rubber or polyurethane material that will allow the passage of large rocks and the like while still providing the seal necessary for the transfer of material. The tank is preferably an open top tank that may be constructed from any material suitable in the art for constructing tanks. The system may be mounted on a vehicle, skid, trailer or any other suitable means for supporting the system.

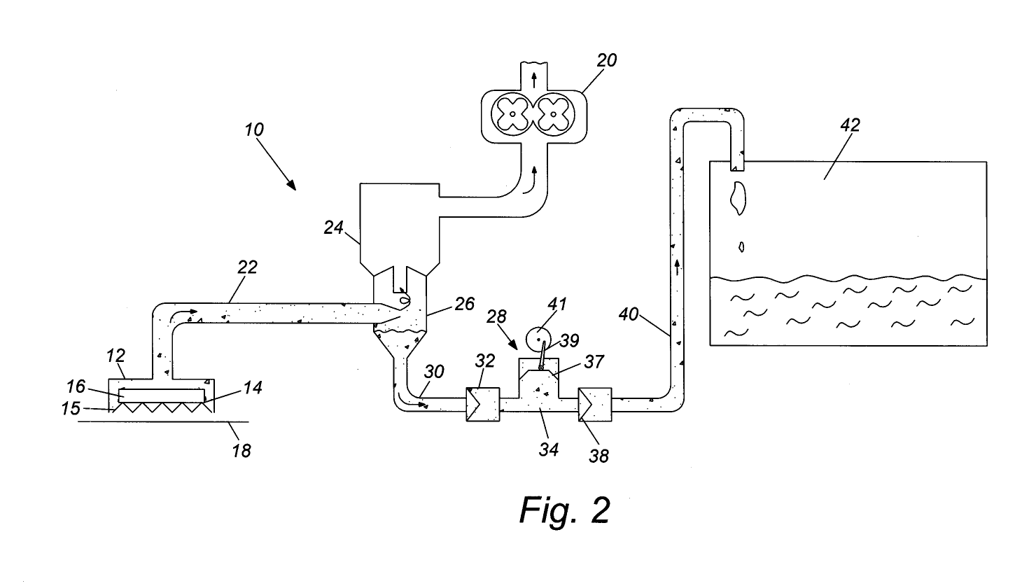

Referring to FIG. 2, an alternative embodiment of the water and debris recovery system 10 is illustrated. The system begins at the blast head 12 where high pressure water 15 is directed through nozzles secured to rotationally mounted spray bar 16. The high pressure water impinges on the surface 18 removing surface markings as well as any loose debris which is trapped within the shroud. Vacuum pump 20 provides a negative air flow through the shroud to draw the water and debris into tube 22. The vacuum pump is preferably a roots type blower however, any pump or fan suitable for creating sufficient vacuum to transfer the water and debris is suitable. Water and debris from tube 22 is directed into a two stage cyclonic separator 24 which allows the water and debris to fallout of the vacuum air flow into the bottom portion 26 of the separator 24. Reciprocating diaphragm 37 of the mud pump 28 then draws the water and debris mix through tube 30 and a first check valve 32 into the central portion of the mud pump 34 for ejection through a second check valve 38. This cycle continues until the water and debris mix is pushed through tube 40 into open tank 42. The mud pump 28 preferably includes at least reciprocating diaphragm 37 which is connected to a connecting rod 39. The diaphragm 37 is preferably connected to an offset wheel or crankshaft 41 which may allow the stroke of the piston to be adjusted as needed to vary the volume transferred during each rotation of the crankshaft. Check valves 32 and 38 are preferably constructed of a material that resists adhesion to sticky polymers and the like which may be found on the surfaces being cleaned. In a most preferred embodiment the check valves are constructed from a rubber or polyurethane material that will allow the passage of large rocks and the like while still providing the seal necessary for the transfer of material. The tank is preferably an open top tank that may be constructed from any material suitable in the art for constructing tanks. The system may be mounted on a vehicle, skid, trailer or any other suitable means for supporting the system.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A water and debris recovery system comprising:
a blast head having at least nozzle therein, said nozzle constructed and arranged to direct high pressure fluid against a surface for impingement thereon, said blast head having a shroud at least partially surrounding said at least one nozzle for substantially containing said high pressure fluid after said impingement,
a vacuum system constructed and arranged to provide a negative pressure air flow through said shroud sufficient to draw said fluid into a tubular member, said tubular member fluidly connected to a separator, said separator being constructed and arranged to separate said air flow and said fluid,
a mud pump assembly, said mud pump assembly including a reciprocating member for drawing said separated fluid from said separator during movement in a first direction, said fluid directed to an open topped tank during movement of said reciprocating member in a second direction, and
a tank for containing said separated fluid.

2. The water and debris recovery system of claim 1 wherein said vacuum system includes a roots type blower for creating said negative air flow.

3. The water and debris recovery system of claim 1 wherein said separator is a cyclonic separator.

4. The water and debris recovery system of claim 1 wherein said separator is a two stage cyclonic separator.

5. The water and debris recovery system of claim 1 wherein said mud pump assembly includes a main body, said main body having an inlet and an outlet and a variable volume pump chamber, whereby variation in said pump chamber volume creates a negative pressure when said pump chamber volume is expanded and a positive pressure when said pump chamber volume is collapsed.

6. The water and debris recovery system of claim 5 wherein said variable volume pump chamber includes a piston mounted for reciprocation within a cylinder.

7. The water and debris recovery system of claim 6 wherein said piston is operably connected to a first end of a connecting rod member, a second end of said connecting rod member secured to an offset crank member, whereby rotation of said offset crank member causes reciprocation of said piston within said cylinder.

8. The water and debris recovery system of claim 7 wherein said offset crank member includes an adjustable offset.

9. The water and debris recovery system of claim 5 wherein said inlet includes a first check valve constructed and arranged to allow said separated fluid to enter said variable volume pump chamber and said outlet includes a second check valve constructed and arranged to allow said separated fluid to exit said variable volume pump chamber.

10. The water and debris recovery system of claim 9 wherein said first and said second check valves are constructed of a polymeric material that resists adhesion to sticky polymers.

11. The water and debris recovery system of claim 10 wherein said check valves are constructed from rubber.

12. The water and debris recovery system of claim 10 wherein said check valves are constructed from polyurethane.

13. The water and debris recovery system of claim 5 wherein said variable volume pump chamber includes a diaphragm having an outer perimeter edge fixedly secured so that a central portion of diaphragm may be reciprocated to alter said volume within said variable volume chamber.

14. The water and debris recovery system of claim 13 wherein said diaphragm is operably connected to a first end of a connecting rod member, a second end of said connecting rod member secured to an offset crank member, whereby rotation of said offset crank member causes reciprocation of said piston within said cylinder.

15. The water and debris recovery system of claim 14 wherein said offset crank member includes an adjustable offset.

16. The water and debris recovery system of claim 14 wherein said inlet includes a first check valve constructed and arranged to allow said separated fluid to enter said variable volume pump chamber and said outlet includes a second check valve constructed and arranged to allow said separated fluid to exit said variable volume pump chamber.

17. The water and debris recovery system of claim 16 wherein said first and said second check valves are constructed of a polymeric material that resists adhesion to sticky polymers.

18. The water and debris recovery system of claim 17 wherein said check valves are constructed from polyurethane.

19. The water and debris recovery system of claim 1 wherein said tank is an open topped tank.

20. The water and debris recovery system of claim 1 wherein said water and debris recovery system is mounted on a vehicular frame.
